(19) United States
(12) Patent Application Publication
(10) Pub. No.: US 2026/0095479 A1
(43) Pub. Date: Apr. 2, 2026

(54) IDENTIFYING MALICIOUS NETWORK TRAFFIC BEHAVIOR USING FLOW-BASED PACKET PAYLOAD LENGTH AGGREGATION

(71) Applicant: Sophos Limited, Abingdon (GB)

(72) Inventors: Tristan Parker Mayfield, Bluffdale, UT (US); John Franklin Limb, Herriman, UT (US); Neil Richard Terry, Cedar Hills, UT (US); James B. Anderson, Rincon, GA (US)

(21) Appl. No.: 19/018,538

(22) Filed: Jan. 13, 2025

Related U.S. Application Data
(60) Provisional application No. 63/700,426, filed on Sep. 27, 2024.

(51) Int. Cl. H04L 9/40

(52) U.S. Cl. CPC H04L 63/1441; H04L 63/1425

(57) ABSTRACT

In example embodiments, techniques are provided for identifying malicious network traffic behavior by aggregating packet payload length of packets of a target packet flow that are part of same segments (e.g., same TCP segments) to produce segment payload lengths (e.g., TCP segment payload lengths), and using the segment payload lengths for identification. An encrypted payload analytics (EPA) engine of network detection and response (NDR) software may generate a target image from the segment payload lengths by organizing data points based on the segment payload lengths into a matrix, and converting the data points in the matrix into pixels of the target image. The EPA engine may then apply the target image to a trained machine learning (ML) model to determine a likelihood network traffic behavior is malicious network traffic behavior. In response to the likelihood, the NDR software may perform a remedial action.

### RELATED APPLICATIONS

The present application claims the benefit of U.S. Provisional Ser. No. 63/700,426 by Mayfield et al., titled “Identifying Malicious Network Traffic Behavior Using Flow-Based Packet Payload Length Aggregation,” filed on Sept. 27, 2024, the contents of which are incorporated by reference herein.

### BACKGROUND

### Technical Field

The present application relates generally to identifying malicious network traffic behavior, and more specifically to identifying malicious network traffic behavior based on packet flows.

### Background Information

When software applications communicate over a network (e.g., the Internet) they often use a transport layer protocol, for example a connection-oriented transport layer protocol such as Transmission Control Protocol (TCP), to establish a flow. One application (referred to as a “client application”) may initiate a flow with (e.g., by sending a connection to) another application (referred to as a “server application”), for example, as part of a handshake (e.g., a three-way handshake). Once a flow is initiated (e.g., a connection is established), the transport layer protocol (e.g., TCP) determines how to break application data into units referred to as “segments” (e.g., TCP segments). These segments may be further subdivided into packets (e.g., by the network layer), that satisfy network parameters (e.g., that conform to a maximum transfer unit (MTU) value), that are sent in the packet flow over the network. After receiving packets, an acknowledgment (ACK) is typically sent to confirm receipt. If an ACK is not received within a specified timeout period, a segment may be retransmitted. Eventually, the flow may be terminated (e.g., the connection closed), using an additional handshake (e.g., a four-way handshake).

Techniques have been developed that examine packet flows to identify malicious network traffic behavior that may be produced by client and/or server applications that are malicious software applications. In this context, the term “malicious network traffic behavior” refers to communication behavior on a network that is produced by, the result of, or is otherwise associated with, a virus, malware, spyware, a worm, a logic bomb, a Trojan, a rootkit, or some combination thereof. In this context, the term “malicious software application” or simply “malicious application” refers to a software application that has been infected by, interfaces with, controls, or is controlled by, a virus, malware, spyware, a worm, a logic bomb, a Trojan, a rootkit, or some combination thereof. One common technique used to identify malicious network traffic behavior is deep packet inspection (DPI). DPI is a type of data processing that inspects in detail packets of a flow, including packet payloads, and searches for signatures therein. DPI may be able to identify malicious network traffic behavior in situations that are not revealed by examination of packet headers alone. However, DPI has a number of shortcomings. One problem with DPI is that it typically consumes a large amount of computing resources (e.g., processing and/or memory resources). This may overburden the hardware of network analysis devices and thereby prevent the inspection of all packets (e.g., when a network analysis device become overburdened and falls behind it may skip packets). Another problem with DPI is that it typically relies upon the ability to read packet payloads. However, increasingly packet payloads are being encrypted (e.g., using Transport Layer Security (TLS) protocol). It is often impossible for a network analysis device that employs DPI to gain access to encrypted payloads of encrypted packet flows, thereby precluding the use of DPI in many situations.

More recently, techniques have been developed that look to a combination of packet payload lengths and the time period between arrivals of packets for identification. Such techniques may address many of the shortcomings of DPI, including reducing computing resources consumption and accommodating encrypted packet flows. However, inconsistencies have been noticed on some networks with these techniques, such that sometimes identifications are not made.

Accordingly, there is need for improved techniques for identifying malicious network traffic behavior that can provide consistent results across a wide variety of networks, while reducing resource consumption and accommodating encrypted packet flows.

### SUMMARY

In various example embodiments, improved techniques are provided for identifying malicious network traffic behavior by aggregating packet payload length of packets of a target packet flow that are part of same segments (e.g., same TCP segments) to produce segment payload lengths (e.g., TCP segment payload lengths), and using the segment payload lengths for identification. Network detection and response software (NDR) software may aggregate packet payload lengths by adding together packet payload lengths of one or more packets (e.g., non-handshake packets) of the target packet flow until an indicator (e.g., a TCP Finish (FIN) flag, a TCP Reset (RST) flag, or a TCP Push (PSH) flag) is encountered in a packet. The packet payloads may be encrypted payloads, and the NDR software may produce the segment payload lengths without decrypting the encrypted payloads. An encrypted payload analytics (EPA) engine of the NDR software may generate a target image from the segment payload lengths by organizing data points based on the segment payload lengths into a matrix, and converting the data points in the matrix into pixels of the target image. The EPA engine may then apply the target image to a trained machine learning (ML) model (e.g., a convolutional neural network CNN trained upon training images from training packet flows exhibiting known malicious network traffic behavior) to determine a likelihood a network traffic behavior is a malicious network traffic behavior. In response to the likelihood, the NDR software may perform a remedial action (e.g., provide an alert, block execution of an application, block communication with an application, etc.).

In comparison to prior techniques that have involved DPI, the present techniques may consume a reduced amount of computing resources enabling them to operate on less powerful network analysis devices, and to more completely inspect packets traveling in a network (e.g., not become overburdened and skip packets). Likewise, they can work with encrypted packet flows. In comparison to prior techniques that have looked to a combination of packet payload lengths and the time period between arrivals of packets in a packet flow, the present techniques may provide more consistent results across results across a wide variety of networks. Use of different MTU values in different networks may cause the same packet payloads to be split differently, resulting in different packet payload lengths. It has been discovered that these MTU-based difference can hinder consistent identification. Segment payload length is typically unaffected by differences in MTU values, and thereby may provide a basis for more consistent identification. A wide variety of other computing efficiency, reliability and other advantages may also be achieved by the present techniques.

In one example embodiment, a method is provided for identifying malicious network traffic behavior. NDR software executing on one or more computing devices captures packets of a target packet flow traveling over a network between a target client application and a target server application. The packets of the target packet flow have respective packet payload lengths. The NDR software aggregates the packet payload length of one or more packets of the target packet flow that are part of same segments to produce a plurality of segment payload lengths. A target image is generated from the segment payload lengths by organizing data points based on the segment payload lengths into a matrix and converting the data points in the matrix into pixels of the target image. The target image is applied to a trained machine learning (ML) model configured to determine a likelihood network traffic behavior between the target client application and the target server application is malicious network traffic behavior. The NDR software performs a remedial action in response to the likelihood.

In another example embodiment, an apparatus is provided for identifying network traffic behavior. The apparatus includes one or more processors and one or more memories coupled to the one or more processors, where the one or more memories are configured to store NDR software. The NDR software when executed on the one or more processors is operable to determine segment payload lengths of segments of a target packet flow traveling over a network between a target client application and a target server application, wherein one or more of the segments include a plurality of packets having payloads split due to MTU value used in the network. The NDR software is further operable to generate a target image from the segment payload lengths. The NDR software is still further operable to apply the target image to a ML model trained upon training images generated from training packet flows exhibiting known malicious network traffic behavior and determine a likelihood the network traffic behavior between the target client application and the target server application is malicious network traffic behavior based on an extent a pattern in the target image matches a pattern in one or more of the training images. The NDR software is also operable to perform a remedial action in response to the likelihood.

In yet another example embodiment, a non-transitory computing device readable medium is provided having instructions encoded thereon. The instructions when executed by one or more computing devices is operable to capture packets of a target packet flow traveling over a network between a target client application and a target server application, the packets of the target packet flow having respective packet payload lengths. The instructions are further operable to aggregate packet payload length of one or more packets of the target packet flow that are part of same TCP segments to produce a plurality of segment payload lengths and to generate target data from the segment payload lengths. The instructions are still further operable to apply the target data to a trained ML model configured to determine a likelihood network traffic behavior between the target client application and the target server application is malicious network traffic behavior. The instructions are also operable to provide an output indicating the network traffic behavior is likely malicious network traffic behavior in response to the likelihood.

It should be understood that a wide variety of additional features and alternative embodiments may be implemented other than those discussed in this Summary. This Summary is intended simply as a brief introduction to the reader for the further description that follows and does not indicate or imply that the examples mentioned herein cover all aspects of the disclosure or are necessary or essential aspects of the disclosure.

### BRIEF DESCRIPTION OF THE DRAWINGS

The description below refers to the accompanying drawings of example embodiments, of which:

FIG. 1 is a block diagram of an example system in which improved techniques may be implemented for identifying network traffic behavior;

FIG. 2 is a diagram of a segment (e.g., TCP segment) that has been split into packets in different manners due to different MTU values;

FIG. 3 is a flow diagram of an example sequence of steps for an improved technique for identifying malicious network traffic behavior;

FIG. 4 is diagram of an example target packet flow that may be captured by NDR software as part of a step of FIG. 3; and

FIG. 5 is an example target image that may be produced by the EPA engine of the NDR software for an example target packet flow as part of operation of a step of FIG. 3

### DETAILED DESCRIPTION

The following detailed description describes example embodiments. Any documents mentioned herein should be considered to be incorporated by reference in their entirety. Any references to items in the singular should be understood to include items in the plural, and vice versa, unless explicitly stated otherwise or otherwise clear from the context. Grammatical conjunctions are generally intended to express any and all disjunctive and conjunctive combinations of conjoined clauses, sentences, words, and the like, unless otherwise stated or clear from the context. For example, the term “or” should generally be understood to mean “and/or.”

Any recitation of ranges of values are not intended to be limiting, are provided as example only, and are not intended to constitute a limitation on the scope of the described embodiments. Further, any recitation of ranges should be interpreted as referring individually to any and all values falling within the range, unless otherwise indicated, and each separate value within such a range should be treated as if it were individually recited. Terms of approximation such as “about,” “approximately,” “substantially” or the like, should be construed as referring to an allowance for deviation that is appreciated by one of ordinary skill in the art to still permit satisfactory operation for the corresponding use, function, purpose, or the like. No language in the description should be construed as indicating that an element is a necessary or essential aspect of the disclosure. Further, terms such as “first,” “second,” “top,” “bottom,” “up,” “down,” and the like, should be considered to be words of convenience and do not preclude differing orderings or orientations.

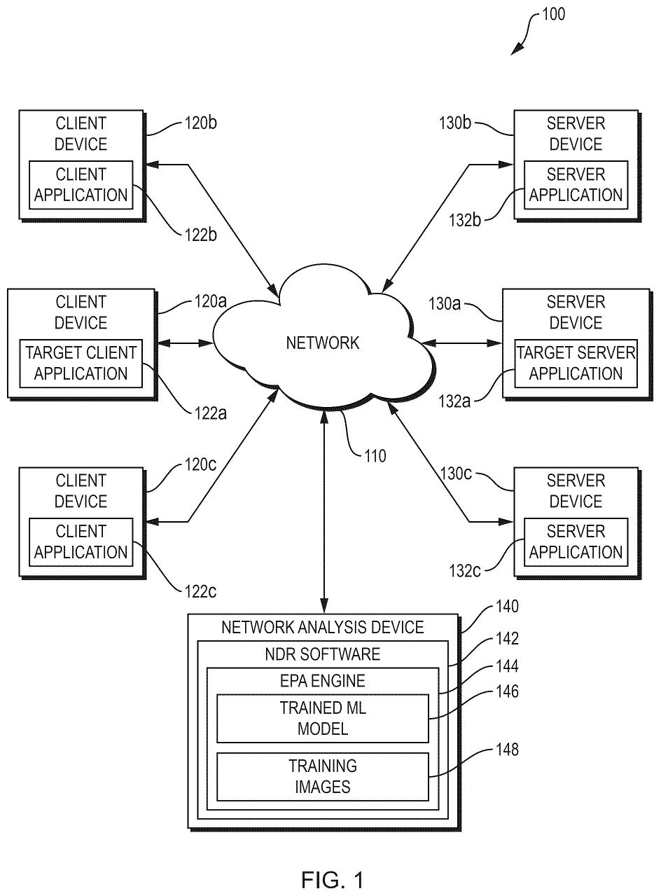

FIG. 1 is a block diagram of an example system 100 in which improved techniques may be implemented for identifying malicious network traffic behavior. The system may include a network 110, and one or more client devices 120a-120c, server devices 130a-130c, and network analysis devices 140, among other components. The network 110 may be a wide area network (WAN) (e.g., the Internet), a local area network (LAN), a storage area network (SAN), or another type of network or combination of networks. The one or more client devices 120a-120c, server devices 130a-130c, and network analysis devices 140, may each be computing devices that include processors, memory/storage, display screens, and/or other hardware (not shown) for executing software, storing, and accessing data, receiving input and/or displaying output.

The one or more client devices 120a-120c may include client applications 122a-122c that send requests to other applications over the network 110 to establish packet flows. In some implementations, the client applications 122a-122c may function as TCP clients initiating a handshake (e.g., a three-way handshake) to open a connection. After the flow is established (e.g., the connection is opened), the client applications 122a-122c may send segments (e.g., TCP segments) that include payloads with application data. The segments may be divided into individual packets for transmission through the network 110 (e.g., by network layer).

The one or more server devices 130a-130c may include server applications 132a-132c that receive the requests (e.g., receive the connection requests) from client applications 122a-122c over the network 110 to establish the packet flows (e.g., open the connections). In some implementations, the server applications 132a-132c may function as TCP servers replying as part of a handshake (e.g., a three-way handshake). The server applications 132a-132c may also send segments (e.g., TCP segments) that include payloads with application data. Again, the segments may be divided into individual packets for transmission through the network 110 (e.g., by network layer).

It should be understood that depending on the current use, client applications 122a-122c may also function as server applications 132a-132c, and server applications 132a-132c may also function as client applications 122a-122c. Likewise, the designation of a particular device as a client device 120a-120c or a server device 130a-130c may be relative to the current function of the applications on the device, and thereby may change.

One or more of the client applications 122a-122c and/or server applications 132a-132c may be malicious software applications that have been infected by, interfaces with, control, and/or are controlled by a virus, malware, spyware, a worm, a logic bomb, a Trojan, a rootkit, or some combination thereof. When such a malicious software application is executing, it may cause malicious network traffic behavior. The corresponding client device 120a-120c or server device 130a-130c the malicious software application is executing on may be considered a “malicious device.”

The one or more network analysis devices 140 may include NDR software 142 that, among other functions, is tasked with identifying malicious network traffic behavior and performing a remedial action. The NDR software 142 may be configured to passively monitor packet flows between the client applications 122a-122c and server applications 132a-132c, for example, by listening on switched port analyzer (SPAN) or mirror ports of network devices of the network 110. The monitoring may capture packet header information, such as source and destination addresses, protocols used, duration of communication, and the like. The NDR software 142 may organize captured packets by packet flow. One specific type of packet header information that may be captured is indicators of flow state (e.g., indicators or connection state, such as TCP flags).

The NDR software 142 may also capture packet payload information for both clear-text and encrypted packet payloads. One specific type of packet payload information that may be captured is packet payload length, which may be observed without decrypting encrypted packet payloads. As explained in more detail below, in one embodiment, the NDR software 142 may be configured to use the indicators of flow state (e.g., indicators or connection state, such as TCP flags) to aggregate packet payload length of packets of packet flows that are part of same segments (e.g., same TCP segments) to produce segment payload lengths.

The NDR software 142 may employ a number of individual engines that employ different strategies for identifying malicious network traffic behavior. These engines may include an EPA engine 144 configured to identify malicious network traffic behavior based on patterns in packet flows between client applications 122a-122c and server applications 132a-132c. When a packet flow is the current subject of analysis by the EPA, the packet flow may be referred to as the “target packet flow” and the respective client and server applications may be referred as the “target client application” 122a and the “target server application”132a, in turn.

The EPA engine 144 may identify malicious network traffic behavior by generating a target image for a target packet flow based on the packet payload data, and applying the target image to a trained ML model (e.g., a CNN) 146 to determine a likelihood the network traffic behavior is malicious network traffic behavior. As explained in more detail below, in one embodiment, the EPA engine 144 may be configured to generate the target image from segment payload lengths (e.g., TCP segment payload lengths) by organizing data points based on the segment payload lengths into a matrix and converting the data points in the matrix into pixels of the target image. The ML model 146 may have been trained upon a set of training images 148 generated from training packet flows exhibiting known malicious network traffic behavior.

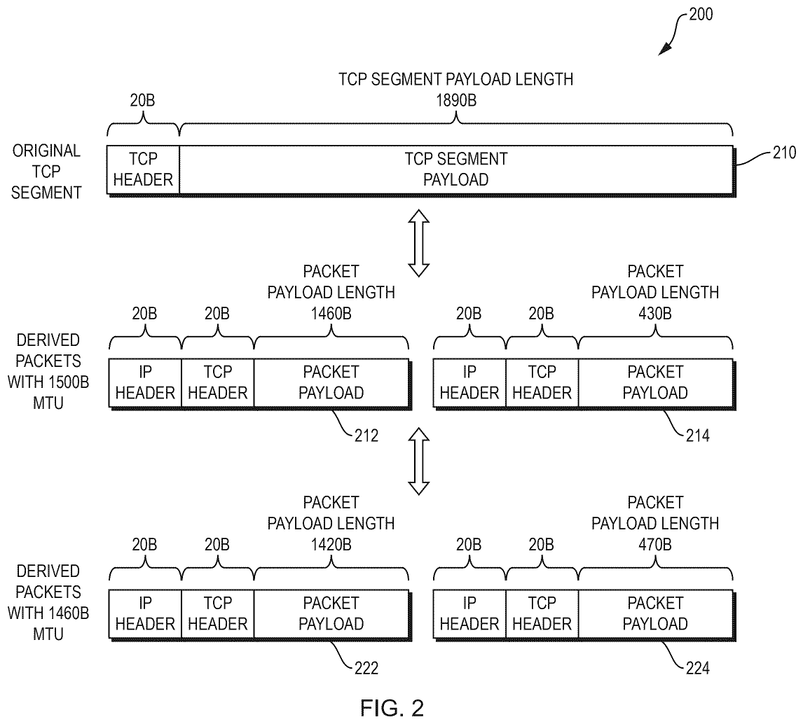

FIG. 2 is a diagram 200 of a segment (e.g., TCP segment) 210 that has been split into packets 212, 214, 222, 224 in different manners due to different MTU values. Some devices may allow segments (e.g., TCP segments) 210 to be larger than a MTU value used in the network, and split such segments into packets that comply with the MTU value. As such, the packet payload length of packets derived from the same segment may vary depending on the MTU value. Referring to FIG. 2, considering a segment (e.g., TCP segment) 210 having a segment payload length of 1890 bytes (B). In a network using a MTU value of 1500 B, the segment may be split (accounting for packet headers) into two packets 212, 214 having packet payload lengths of 1460 B and 430 B, respectively. If the network instead used a MTU value of 1460 B, the segment may be split into two packets 222, 224 having packet payload payloads of 1420 B and 470 B, respectively. It has been discovered that if packet payload lengths were used directly by the EPA engine 144 to identify malicious network traffic behavior, the occurrence of different lengths for the same underlying payload data may hinder consistent application identification. By aggregating packet payload length of packets of a target packet flow of same segments to produce segment payload lengths, and using the segment payload lengths for identification, more consistent results may be achieved.

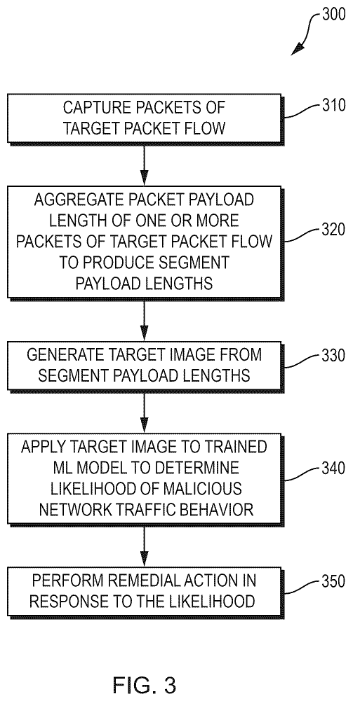

FIG. 3 is a flow diagram of an example sequence of steps 300 for an improved technique for identifying malicious network traffic behavior. At step 310, NDR software 142 executing on one or more network analysis devices 140 captures packets of a target packet flow travelling over the network 110 between a target client application 122a and a target server applications 132a (e.g., by listening on SPAN or mirror ports).

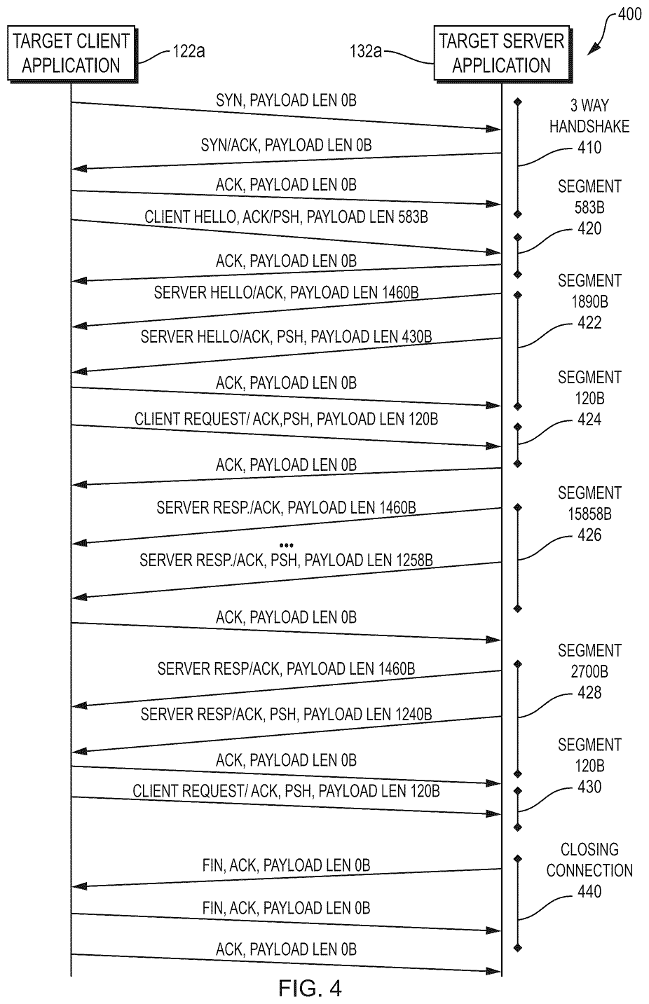

FIG. 4 is diagram 400 of an example target packet flow that may be captured by NDR software 142 as part of step 310 of FIG. 3. In the example, the target packet flow begins with a handshake (e.g., a 3 way handshake) 410 in which handshake packets having zero payload length are exchanged. After the handshake, a number of segments (e.g., TCP segments) 420-430 are exchanged that each include non-handshake packets having payloads with respective payload lengths. While some segments 420, 424, 430 (having segment payload lengths of 583 B, 120 B and 120 B, respectively) are passed in a single packets, due to a MTU value of 1500 B used in this example, other segments 422, 426, 428 (having segment payload lengths of 1890 B, 15858 B and 2700 B, respectively) are split into multiple packets having packet payload lengths no larger than 1460 B (accounting for packet headers). The target packet flow is closed with an exchange 440 of additional handshake packets having zero payload length.

Returning to FIG. 3, at step 320 (which may occur in parallel to step 310) the NDR software 142 aggregates packet payload length of one or more packets (e.g., non-handshake packets) of the target packet flow that are part of same segments (e.g., TCP segments) to produce a set of segment payload lengths (e.g., TCP segment payload lengths). The NDR software 142 may aggregate packet payload length by adding together packet payload lengths of packets of the target packet flow until an indicator (e.g., a TCP FIN flag, a TCP RST flag, or a TCP PSH flag) is encountered in a packet, which signals the end of a segment. The NDR software may produce the segment payload lengths without decrypting any encrypted payloads.

Referring again to the example in FIG. 4, operation of step 320 may produce segment payload lengths of 583 B, 1890 B, 120 B, 15858 B, 2700 B and 120 B, respectively. For segments 420, 424, 430 that are passed as a single packet, the segment payload length may equal the packet payload length of the signal packet. For segments 422, 426, 428 that are split due to the MTU value used in the network, the segment payload lengths may be the sum of the packet payload lengths of the multiple packets.

Returning to FIG. 3, at step 330, the EPA engine 144 of the NDR software 142 generates a target image from the segment payload lengths of the target flow by organizing data points based on the segment payload lengths into a matrix and converting the data points in the matrix into pixels of the target image. In one implementation, the EPA engine 144 normalizes each of the segment payload lengths to produce the data points. The normalization may first convert each of the segment payload lengths to positive integer values (e.g., Int32) values. In their raw state the segment payload lengths may be signed to indicate direction of travel, and the conversion may effectively remove negative signs. The normalization may then pad each positive integer value to a given length. Each digit of the padded positive integer values may be split to produce single-digit integers. The single-digit integers may then be scaled by multiplying them by a given value to produce the data points. Further details of example normalization operations that may be performed may be found in U.S. Pat. No. 11,159,560 by John Franklin Limb, titled “Identifying Network Applications Using Images Generated From Payload Data and Time Data”, the contents of which are incorporated by reference herein.

In one implementation, the EPA engine 144 organizes the data points into the matrix by placing each data point in the matrix beginning at the center of the matrix and spiraling outward (e.g., clockwise) from the center. Each location in the matrix may receive one data point. When the data points are exhausted, if there are remaining locations in the matrix, they may be filled with predetermined values (e.g., zeros). It should be understood, however, that in other implementations the data points may be placed into the matrix in a variety of different manners following any of a variety of filling schemes.

In one implementation, the target image may be a grayscale image and the EPA engine 144 may convert the data points in the matrix into pixels of the target image by using the value of each data point as a representation of brightness of the respective pixel (e.g., with zero interpreted as black and a maximum value, such as 255, as white). Alternatively, the target image may be a color image (e.g., a RGB color image), and the EPA engine 144 may convert the data points in the matrix into pixels of the target image by using the value each data point to set one or more color values of the respective pixel. It should be understood that in other implementations a wide variety of other conversions schemes may also be used.

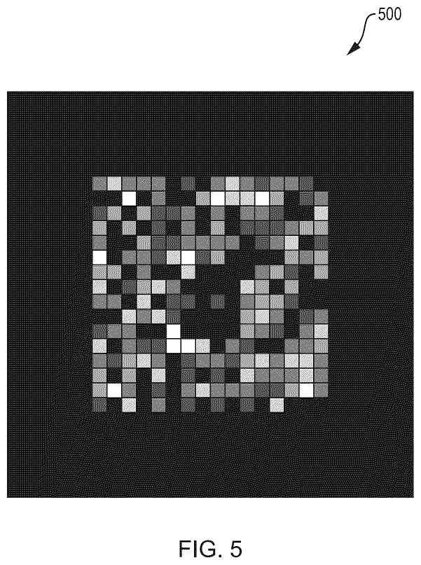

FIG. 5 is an example target image that may be produced by the EPA engine 144 of the NDR software 142 for an example target packet flow as part of operation of step 330 of FIG. 3. In this example, the data points do not fill the entire matrix and the remaining locations have been filled with zeros, which results in a black border around the central portion of the image that includes the representation of the segment payload lengths.

Returning to FIG. 3, at step 340 the EPA engine 144 of the NDR software 142 applies the target image to a trained ML model (e.g., a trained CNN) 146, which has been trained to determine a likelihood network traffic behavior is malicious network traffic behavior. Malicious software applications may produce network traffic that exhibits recognizable patterns of segment payload lengths (e.g., TCP segment payload lengths), for example, tending to send segments with payloads of particular lengths in particular orders, with particular repetitions, or other patterns. These patterns will produce corresponding patterns in target images generated as described above in step 330. The ML model 146 may have been previously trained upon training images 148 (generated in a similar manner as discussed above) from training packet flows exhibiting known malicious network traffic behavior, such that the model 146 is able to recognize images that include similar patterns. When the target image is applied, the ML model 146 may calculate an extent the target image matches patterns exhibited in one or more of the training images 148, and quantify this extent as a likelihood (e.g., between 0% and 100%). Further details of an example of training and determining likelihood by a ML model 146 may be found in U.S. Pat. No. 11,159,560.

At step 350, the NDR software performs a remedial action in response to the likelihood, for example, in response to the likelihood exceeding a predetermined value (e.g., 90%). The remedial action may include providing an alert that the network traffic behavior between the target client application 122a and the target server application 132a is likely malicious network traffic behavior, blocking execution of the target client application 122a and/or the target server application 132a, blocking one or more other applications from communicating with the target client application 122a and/or the target server application 132a, or providing any of a wide variety of other types or output or performing any of a wide variety of other types of operations to protect devices, applications or users thereof. In some cases, the remedial action may include storing information to memory/storage, for example, storing a copy of the target image and/or the target packet flow. Such saved information may be used in subsequent retraining of the ML model 146 to improve identification results.

In conclusion, the above description describes improved techniques for identifying malicious network traffic behavior by aggregating packet payload length of packets of a target packet flow between a target client application and a target server application that are part of same segments (e.g., same TCP segments) to produce segment payload lengths (e.g., TCP segment payload lengths), and using the segment payload lengths for identification. As mentioned above, the techniques may provide a number of advantages. For example, they may consume a reduced amount of computing resources, enabling them to operate on less powerful network analysis devices, and to more completely inspect packets traveling in a network. Likewise, they can work with encrypted packet flows. Further, they can provide consistent results in networks that use different MTU values.

It should be understood that a wide variety of adaptations and modifications may be made to the techniques to suit various implementations and environments. While it is discussed above that aspects of the techniques can be implemented by specific software executing on specific hardware, it should be understood that the techniques may also be implemented by different software, different hardware, or various different combinations thereof that are suitable for a particular environment. Software may include instructions in a high-level programming language (e.g., C++) or low-level programming language (e.g., assembly language, hardware description language, database programming language, etc.) that may be stored, and compiled or interpreted to run on hardware. For example, instructions may be stored on a non-transitory computing-device readable medium that when executed on one or more processors are operable to perform the above techniques.

While it is discussed above that certain portions of the techniques can be arranged or distributed in certain ways, it should be understood a wide variety of other arrangements are also possible, and that portions of the techniques may be distributed across software, hardware, or combinations thereof in a wide variety of other manners. For example, functionality may be distributed across any of the devices or systems described above, or all of the functionality may be integrated into a single device or system. Likewise, means for performing any steps described above may include any of the hardware and/or software described above. All such permutations and combinations are intended to fall within the scope of the present disclosure.

It should be understood that the ordering of any method steps discussed above may be changed to suit various applications or requirements. Absent an explicit indication to the contrary, the order of steps described above may be modified such that a subsequent step occurs before a preceding step, or in parallel to such step.

It should be understood that the above descriptions are meant to be taken only by way of example. Numerous variations, additions, omissions, and other modifications will be apparent to one of ordinary skill in the art, and such variations, additions, omissions, and other modifications should be considered within the scope of this disclosure. Thus, while example embodiments have been shown and described, it will be apparent to those skilled in the art that changes and modifications may be made therein without departing from the spirit and scope of this disclosure.

What is claimed is:

1. A method for identifying malicious network traffic behavior, comprising:
capturing, by network detection and response (NDR) software executing on one or more computing devices, packets of a target packet flow traveling over a network between a target client application and a target server application, the packets of the target packet flow having respective packet payload lengths;
aggregating, by the NDR software, the packet payload length of one or more packets of the target packet flow that are part of same segments to produce a plurality of segment payload lengths;
generating a target image from the segment payload lengths by organizing data points based on the segment payload lengths into a matrix and converting the data points in the matrix into pixels of the target image;
applying the target image to a trained machine learning (ML) model configured to determine a likelihood network traffic behavior between the target client application and the target server application is malicious network traffic behavior; and
performing, by the NDR software, a remedial action in response to the likelihood.

2. The method of claim 1, wherein the segments are TCP segments, the segment payload lengths are TCP segment payload lengths, and the aggregating comprises:
adding together packet payload lengths until an indicator is encountered in a packet of the target packet flow.

3. The method of claim 2, wherein the indicator is a TCP Finish (FIN) flag, a TCP Reset (RST) flag, or a TCP Push (PSH) flag.

4. The method of claim 1, wherein one or more of the segments include a plurality of packets having payloads split due to a maximum transmission unit (MTU) value used in the network.

5. The method of claim 1, wherein the packets of the target packet flow include handshake packets used to conduct a multi-way handshake and non-handshake packets, and the aggregating aggregates packet payload length of the non-handshake packets.

6. The method of claim 1, wherein the packets of a target packet flow include packets having encrypted payloads, and the aggregating produces the plurality of segment payload lengths without decrypting the encrypted payloads.

7. The method of claim 1, wherein the generating further comprises:
normalizing the segment payload lengths to produce the data points; and
placing the data points into the matrix beginning at a center of the matrix and spiraling outward from the center of the matrix.

8. The method of claim 7, wherein the normalizing further comprises:
converting the segment payload lengths to positive integer values;
padding the positive integer values to a given number of digits;
splitting digits of the padded integer values to produce single-digit integers; and
scaling the single-digit integers.

9. The method of claim 1, wherein the trained ML model is a convolutional neural network (CNN) trained upon training images generated from training packet flows exhibiting known malicious network traffic behavior, and the applying further comprises:
calculating an extent a pattern in the target image matches a pattern in one or more of the training images to determine the likelihood.

10. The method of claim 1, wherein the remedial action comprises providing an alert that the network traffic behavior is likely malicious network traffic behavior, blocking execution of the target client application and/or the target server application, or blocking one or more other applications from communicating with the target client application and/or the target server application.

11. An apparatus for identifying malicious network traffic behavior, comprising:
one or more processors; and
one or more memories coupled to the one or more processors, the one or more memories configured to store network detection and response (NDR) software, wherein the NDR software when executed on the one or more processors is operable to:
determine segment payload lengths of segments of a target packet flow traveling over a network between a target client application and a target server application, wherein one or more of the segments include a plurality of packets having payloads split due to a maximum transmission unit (MTU) value used in the network,
generate a target image from the segment payload lengths;
apply the target image to a machine learning (ML) model trained upon training images generated from training packet flows exhibiting known malicious network traffic behavior and determine a likelihood network traffic behavior between the target client application and the target server application is malicious network traffic behavior based on an extent a pattern in the target image matches a pattern in one or more of the training images, and
perform a remedial action in response to the likelihood.

12. The apparatus of claim 11, wherein the segments are TCP segments, the segment payload lengths are TCP segment payload lengths, and the NDR software is operable to determine TCP segment payload lengths by aggregating packet payload length of one or more packets that are part of same TCP segments.

13. The apparatus of claim 12, wherein NDR software is operable to determine same segments based on one or more TCP flags, wherein the one or more TCP flags include a TCP Finish (FIN) flag, a TCP Reset (RST) flag, or a TCP Push (PSH) flag.

14. The apparatus of claim 11, wherein the NDR software is operable to generate the target image by organizing data points based on the segment payload lengths into a matrix, and converting the data points in the matrix into pixels of the target image.

15. A non-transitory computing device readable medium having instructions stored thereon, the instructions when executed by one or more computing devices operable to:
capture packets of a target packet flow traveling over a network between a target client application and a target server application, the packets of the target packet flow having respective packet payload lengths;
aggregate packet payload length of one or more packets of the target packet flow that are part of same Transmission Control Protocol (TCP) segments to produce a plurality of segment payload lengths;
generate target data from the segment payload lengths;
apply the target data to a trained machine learning (ML) model configured to determine a likelihood network traffic behavior between the target client application and the target server application is malicious network traffic behavior; and
provide an output indicating the network traffic behavior is likely malicious network traffic behavior in response to the likelihood.

16. The non-transitory computing device readable medium of claim 15, wherein the instructions operable to aggregate comprise instruction operable to:
add together packet payload lengths until an indicator is encountered in a TCP packet of the target packet flow.

17. The non-transitory computing device readable medium of claim 16, wherein the indicator is a TCP Finish (FIN) flag, a TCP Reset (RST) flag, or a TCP Push (PSH) flag.

18. The non-transitory computing device readable medium of claim 15, wherein one or more of the TCP segments include a plurality of packets having payloads split due to a maximum transmission unit (MTU) value used in the network.

19. The non-transitory computing device readable medium of claim 15, wherein the target data comprises a target image and the instructions operable to generate comprise instructions operable to:
organize data points based on the segment payload lengths into a matrix; and
convert the data points in the matrix into pixels of the target image.

20. The non-transitory computing device readable medium of claim 15, wherein the packets of the target packet flow include packets having encrypted payloads, and the instructions operable to aggregate are operable to produce the segment payload lengths without decrypting the encrypted payloads.
